(19) United States
(12) Patent Application Publication
(10) Pub. No.: US 2011/0308760 A1
(43) Pub. Date: Dec. 22, 2011

(54) APPARATUS FOR PRODUCTION OF METALLIC SLAB USING ELECTRON BEAM, AND PROCESS FOR PRODUCTION OF METALLIC SLAB USING THE APPARATUS

(76) Inventors: Hisamune Tanaka, Kanagawa (JP); Osamu Tada, Kanagawa (JP); Takashi Oda, Kanagawa (JP); Yoshimasa Miyazaki, Tokyo (JP); Kazuhiro Takahashi, Tokyo (JP)

(21) Appl. No.: 13/148,377

(22) PCT Filed: Feb. 8, 2009
(86) PCT No.: PCT/JP2010/051789

§ 371 Date: Aug. 8, 2011

(30) Foreign Application Priority Data
Feb. 9, 2009 (JP) 2009-027335

(51) Int. Cl. B22D 25/06; F27B 3/08; B22D 45/00

(52) U.S. Cl. 164/494; 164/512

(57) ABSTRACT

An apparatus and method allows the width of high-melting temperature reactive metallic slabs produced in an electron beam melting furnace to be easily changed. The apparatus for production of the metallic slabs by the electron beam melting has a metal melting part and a metal extraction part mutually separated by an air tight valve; a metal melting part has a melting chamber, electron gun, hearth, a mold of variable wall distance, and an air tight valve; and the metal extraction part has a slab chamber, an extraction base, an extracting shaft, and an drive unit for extracting the metal slab. The method for production of the metallic slab using this apparatus has a step of pulling a previous metallic slab produced in the rectangular mold out of the rectangular mold, a step of moving the short mold wall(s) of the rectangular mold to change the width of the rectangular mold, and a step of producing a subsequent metallic slab.

### TECHNICAL FIELD

The present invention relates to an electron beam melting technique for a metal, and in particular, relates to an electron beam melting apparatus in which a width of a slab produced by the electron beam melting furnace can be varied, and relates to a process for production of metal slabs using the apparatus.

### BACKGROUND ART

Titanium metal has been conventionally used in airplanes and in chemical plants, and it has recently been used for products familiar to the public such as vehicles, two-wheel vehicles, and sports equipment. Furthermore, titanium metal also plays an important role in production of highly pure titanium ingots for targets used in semiconductors.

The size of an ingot used for these purposes is selected depending on the manner of use, and in the case in which an ingot having a relatively large size is produced, a vacuum arc melting furnace is often used. Furthermore, in the case in which an ingot for a target requiring high purity is produced, an electron beam melting furnace is desirably used.

In the electron beam melting furnace for metal, a mold that produces an ingot having circular cross section is usually used; however, a technique in which a mold is used that can directly produce an ingot having a thin rectangular cross section (hereinafter simply called a “slab”) is known (see Patent Document 1). In the case in which the conventional ingot is processed as a plate material, an intermediate process such as a breaking down process is necessary; however, since the slab has a rectangular cross section, omitting the intermediate process after the slab is produced by the electron beam melting furnace, the slab can be directly fed to a roll to be rolled into a plate material.

On the other hand, as the use of electron beam melting furnaces has recently spread, diversity of widths of the slabs produced is required. In the field of steels, a technique to change the width of a mold has been well known (see Patent Document 2). In such a technique, the width of the mold is continuously decreased while the ingot piece is retained inside the mold. However, a technique in which the width of the slab is increased has not yet been made in the field of continuous casting of steel due to potential for breakout.

However, unlike steel, since titanium metal is reactive, titanium metal when heated cannot be allowed to contact air. Therefore, it is difficult to adapt the techniques for continuous casting of steel as they are for the casting of titanium, and it is necessary that a titanium slab, which is pulled out of a mold, be held in a vacuum, separated from air, and be cooled.

Therefore, unlike steel, in the case in which a titanium slab is melted and produced by an electron beam melting furnace, an operation in which a slab is produced in a closed melting chamber of the melting furnace, the slab is cooled in a closed vessel (hereinafter simply referred to as the “slab chamber”) under reduced pressure conditions, the pressure in the slab chamber is returned to normal pressure, and then the slab is pulled out into normal air, has been performed.

During the operation, after separating the slab chamber and the melting chamber by the air tight valve, the slab chamber is isolated from the melting chamber, and then the extracting operation of the slab is performed in the slab chamber. During this operation, the inside of the melting furnace is held under reduced pressure conditions, which is the atmosphere during melting of the metal.

Therefore, to change a width of the mold when producing titanium, unlike in the situation for steel, the inside the melting chamber is returned to normal pressure, the melting chamber is opened, and then the mold is replaced with a new mold having a different width. Since these processes are complicated, it is necessary to improve these processes.

As mentioned above, a technique for changing a width of a mold in the production of titanium is not disclosed in a prior document, and therefore, a technique in which titanium slabs having different widths can be produced without opening the melting chamber of the electron beam melting furnace and exposing it to normal pressure.

The present invention is an apparatus for production of metallic slabs using electron beam melting furnaces, and a continuous process for production of metallic slabs using this apparatus, and objects of the present invention are to provide an apparatus for production of metallic slabs and for a continuous process for production of metallic slabs using the apparatus, in which metallic slabs each having different widths can be efficiently produced by changing widths of molds in the apparatus, without exposing the apparatus to the normal atmosphere.

Patent Document 1: Japanese Patent Application, Laid Open Publication No. Hei 04 (1992)-131330

Patent Document 2: Japanese Patent Application, Laid Open Publication No. Sho 59 (1984)-073154

### SUMMARY OF THE INVENTION

The inventors have researched to achieve the objects mentioned above and have found that metallic slabs each having a different width can be produced while maintaining the atmosphere in the melting chamber, by providing a melting chamber, electron gun, hearth, rectangular mold of variable wall distance and air tight valve in the metallic melting part of the electron beam melting apparatus for producing metal, and further by providing a slab chamber, extraction base, extracting shaft, and driving unit for extracting device in the part of extracting the metal slab, and thus the present invention as follows has been completed.

That is, an apparatus for production of metallic slabs using an electron beam of the present invention has a part of melting metal and a part of extracting the metal slab which can be mutually separated by an air tight valve, the part of melting metal has a melting chamber, an electron gun, a hearth, a rectangular mold in which the width can be varied, and the air tight valve, and the part of extracting the metal slab has a slab chamber, an extraction base, an extracting shaft, and a driving unit for extracting the metal slab.

In the apparatus for production of the metallic slab according to the present invention, it is desirable that the rectangular mold of variable wall distance have a pair of mold walls of a long side and a pair of the short mold waist, and the short mold wall can be slidably moved along the surface of the mold wall of the long side by a wall driving shaft arranged penetrating through a shaft guide.

In the apparatus for production of metallic slabs according to the present invention, it is desirable that one of the wall driving shafts be connected to one of the pair of the short mold walls, and the other of the wall driving shafts be connected to the other of the pair of the short mold walls, the short mold walls facing each other, one wall driving shaft is connected to a motor via a shaft driving device and motor driving shaft, and the other wall driving shaft is connected to the motor via a shaft driving device and power transmission shaft and a motor driving shaft.

In the apparatus for production of metallic slabs according to the present invention, it is desirable that the motor driving shaft be connected to the motor which is arranged outside the electron beam melting furnace, via an O-ring bearing arranged penetrating the furnace wall of the electron beam melting furnace.

Furthermore, in the apparatus for production of metallic slabs according to the present invention, it is desirable that one of the wall driving shafts be connected to one of the pair of the short mold walls, and the other of the wall driving shafts be connected to the other of the pair of the short mold walls, the short mold walls facing each other, one wall driving shaft is connected to a motor via a shaft driving device and motor driving shaft, the other wall driving shaft is connected to the shaft driving device, the power transmitting shaft, the motor driving shaft, and the motor, and the motor and all the driving devices are arranged inside the electron beam melting furnace.

A process for production of metallic slabs using the apparatus for production of metallic slabs of the present invention has a step of pulling out the previous metallic slab produced in the rectangular mold, a step of moving the short mold wall(s) forming the rectangular mold to change the width of the rectangular mold, and a step of producing a subsequent metallic slab having a width different from the previous one.

In the process for production of metallic slabs according to the present invention, it is desirable that the short mold wall(s) of the rectangular mold be moved so that the width of the rectangular mold is shortened.

Furthermore, in the process for production of metallic slabs according to the present invention, it is desirable that only one of the short mold walls of the rectangular mold be moved during changing the width of the rectangular mold.

Furthermore, in the process for production of metallic slabs according to the present invention, it is desirable that the following steps be performed after melting and producing the metallic slab:

step 1: the extraction base of the slab is moved upwardly until the extraction base enters into the rectangular mold,

step 2: after the extraction base enters into the rectangular mold, the short mold wall(s) of the rectangular mold and the extraction base are contacted once, and then the short mold wall(s) are moved apart from the extraction base so that the extraction base can be moved downwardly,

step 3: molten metal is poured from the hearth into the rectangular mold, and at the same time, the extraction base is moved continuously downwardly so as to produce a metallic slab having a predetermined length,

step 4: after producing the metallic slab, the extraction base and the metallic slab are moved downwardly together until the entirety of the metallic slab is contained in the slab chamber, to pull the metallic slab out from the rectangular mold,

step 5: after the metallic slab is pulled out into the slab chamber, the air tight valve is driven so that inside the melting chamber is separated from the air, pressure inside the slab chamber is returned to normal pressure and cooled, and then the metallic slab is taken out of the slab chamber,

step 6: after the inside the melting chamber is separated from the air by the air tight valve, while maintaining the inside of the melting chamber at reduced pressure, the short mold wall(s) of the rectangular mold are moved to change the width of the mold, and

step 7: a new extraction base which fits to the mold whose width is changed, is inserted into the rectangular mold, and then melting and production of a new slab is restarted.

By using the apparatus and process for production of metallic slabs using the electron beam mentioned above, the slab can be pulled out from the rectangular mold to the part of extracting the metal slab while maintaining reduced pressure or a vacuum in the metal melting part. As a result, a width of the rectangular mold held in the metal melting part can be easily varied while maintaining reduced pressure or a vacuum, and slabs each having a different width can be produced efficiently.

### BRIEF DESCRIPTION OF DRAWINGS

FIG. 1 is a cross sectional view showing the apparatus for production of metallic slabs in which an electron beam is used.

FIG. 2 is a plane view showing the mold of variable wall distance according to the first embodiment of the present invention.

FIG. 3 is front view showing the mold of variable wall distance.

FIG. 4 is a conceptual view showing a scraping device that scrapes the inner surface of the rectangular mold.

FIG. 5 is a plane view showing the mold of variable wall distance according to the second embodiment of the present invention.

FIG. 6 is a plane view showing the mold of variable wall distance according to the third embodiment of the present invention.

FIG. 7 is a plane view showing the mold of variable wall distance according to the fourth embodiment of the present invention.

### EXPLANATION OF REFERENCE NUMERALS

1: Air tight valve, 2: Rectangular mold, 3: Hearth, 4: Extraction base, 5: Extracting shaft driving device, 6: Electron gun, 7: Melting chamber, 8: Slab chamber, 10: Metallic slab, 11: Extracting shaft, 21: Mold wall of long side, 22: Short mold wall, 23: Shaft guide, 24: Wall driving shaft, 25: Shaft driving device, 26: Power transmitting shaft, 27: Motor driving shaft, 28: 0 ring, 29: Motor, 30: Electron beam melting furnace wall, 31: Speed changer, 32: Speed changer, 50: Mold inner surface scraping device, 51: Wire brush, L: Metal melting part, M: Part of extracting the metal slab

### BEST MODE FOR CARRYING OUT THE INVENTION

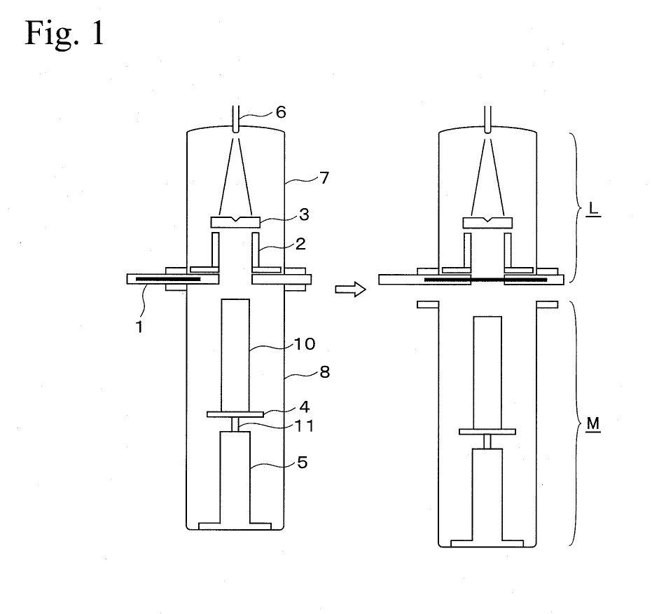

Preferable embodiments of the invention are explained with reference to the drawings below. FIGS. 1 to 3 show preferable examples of the present invention.

FIG. 1 shows an example of a preferable structure of the apparatus for production of metallic slabs of the present invention. The melting apparatus consists of a metal melting part L and a part of extracting the metal slab M. The metal melting part L has a melting chamber 7 in which an electron gun 6 is arranged at a top thereof. Inside of the melting chamber 7, a hearth 3, which holds raw material melted by the electron beam, and a mold of variable wall distance rectangular mold 2, which solidifies the metal melted in the hearth 3, are arranged. Furthermore, on the bottom part of the melting chamber 7, an air tight valve 1 which protects the inside of the melting chamber from the air is arranged.

The part of extracting the metal slab M can be detached from the metal melting part L as shown in FIG. 1, and in the inside of the part of extracting the metal slab, a slab 10 which is melted, cooled, and solidified, and a pullout means for pulling the slab 10 out of the mold, are arranged. The pullout means consists of an extraction base 4, which engages with the slab 10, an extracting shaft 11, and an extracting shaft driving means 5.

First, a raw material is supplied from a raw material supplying device, which is not shown in the figure, to the hearth 3 in the metal melting chamber 7. The raw material supplied in the hearth 3 is heated and melted by an electron beam emitted from the electron gun 6 held at the top part of the melting chamber 7. The molten metal which is heated and melted is continuously supplied to the rectangular mold 2 in which the extraction base 4 has been elevated in advance and inserted therein.

The molten metal supplied in the rectangular mold 2 is solidified by the water-cooled rectangular mold 2 absorbing the heat thereof. The slab that has solidified is pulled out continuously downwardly by the pullout means engaging with the slab by operating the extracting shaft driving means. The metal slab 10 continuously pulled out can be produced until reaching a length that is containable in the slab chamber.

After the metal slab 10 having a predetermined length is produced, supply of the raw material to the hearth 3 is stopped, the metal slab 10 is pulled out of the rectangular mold 2 completely, confirming whether the top part of the metal slab 10 is completely contained in the slab chamber 8, the air tight valve 1 is closed, and the boundary of the melting chamber 7 and the slab chamber 8 is separated. Then, after confirming whether the slab 10 has cooled to a predetermined temperature, pressure inside of the slab chamber 8 is returned to normal pressure, and the part of extracting the metal slab M is detached from the metal melting part L.

The metal slab 10 can be taken out of the slab chamber 8 from an opening side of the part of extracting the metal slab M detached from the metal melting part L. During the pullout process of the metal slab 10, it should be noted that it is desirable to confirm whether the metal slab 10 has cooled to about 500 to 600° C. in order to prevent the metal slab 10 from reacting with the air.

### First Embodiment

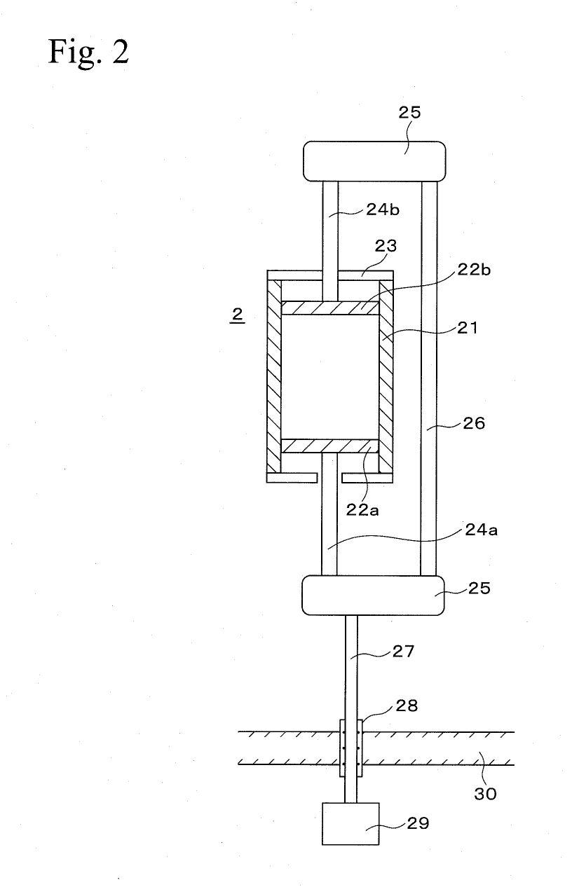

In the present invention, after the pullout operation of the metal slab 10, the width of the rectangular mold 2 arranged in the metal melting part L can be changed. FIG. 2 shows a desirable feature of the rectangular mold of variable wall distance 2 used in the process for production of metal ingot according to the first embodiment of the present invention. FIG. 2 is a diagram in which the rectangular mold 2 in FIG. 1 is seen from above.

The rectangular mold 2 in this embodiment is constructed by mold walls of a long side 21 and short mold walls 22a and 22b are mutually connected to wall driving shafts 24a and 24b each penetrating shaft guides 23. The wall driving shafts 24a/24b are connected to each of shaft driving devices 25, and the shaft driving devices 25 are connected to each other by a power transmitting shaft 26. The shaft driving devices 25 are connected to a wall driving motor 29 arranged in the air which is outside of the electron beam melting furnace wall 30, via the motor driving shaft 27 held by a O-ring bearing 28 separating the air from the inside of the melting furnace.

By arranging the wall driving motor 29 in the air and which is outside of the furnace, rather than arranging the inside of the electron beam furnace in which pressure is reduced, evaporating loss of lubricating oil which is used on a driving axis of the wall driving motor 29 can be effectively prevented. As a result, the wall driving motor 29 can be effectively prevented from being heated.

Furthermore, by arranging the wall driving motor 29 of the present invention outside of the electron beam melting furnace, a short circuit accident between a power cable supplying electric power to the wall driving motor 29 and the electron beam melting furnace can be prevented, and thus the present invention is effective in safety.

In the one shaft driving device 25 which is directly connected to the motor driving shaft 27, it is desirable that a mechanism which can transmit motive power to both the wall driving shaft 24a which is directly connected to the short mold wall 22a close to the electron beam melting furnace wall 30 and the power transmitting shaft 26 at the same time, be provided.

According to the above-mentioned structure of the mechanism, by using the wall driving motor 29 arranged outside of the electron beam melting furnace, via each of the wall driving shaft 24a and the power transmitting shaft 26, a pair of the short mold walls 22a/22b can be driven simultaneously, and as a result, the width of the rectangular mold 2 can be freely changed by operations outside the furnace.

In addition, in the shaft driving device 25 directly connected to the motor driving shaft 27, it is desirable that a clutch mechanism which temporally blocks driving power from the wall driving motor 29 to one of the power transmitting shaft 26 or the wall driving shaft 24a be provided.

By providing the above-mentioned clutch mechanism, the driving power of the wall driving motor 29 can be transmitted to only the short mold wall 22a without being transmitted to the power transmitting shaft 26, or conversely can be transmitted to only the power transmitting shaft 26 without being transmitted to the short mold wall 22a. By this mechanism, the short mold walls 22a/22b can be asymmetrically driven.

This is very effective in a case in which the molten metal is poured from one of the short mold walls 22 of the rectangular mold 2. By pouring the molten metal from one of the short mold walls of the rectangular mold 2, there is a temperature distribution in which temperature is decreased from one mold wall (22a or 22b) of a short side of pouring side to the other mold wall of a short side. Since this temperature distribution is a symmetric distribution concerning the mold wall of a long side 21 and the other mold wall of a long side facing, temperature distribution of the metal slab 10 along a thickness direction is uniform, and as a result, deformation along the longitudinal direction of the metal slab 10 produced is effectively reduced, and thus a metal slab 10 having superior linearity can be produced. This embodiment is appropriate in particular in the case in which a metal slab 10 having a small thickness is produced.

Furthermore, in the present invention, a width of the rectangular mold 2 can be reduced even during melting and production of the metal slab 10. By performing the operation to shorten the width, drip down of the molten metal from a pool formed on top of the metal slab 10 to a side surface of the metal slab 10, can be effectively reduced.

In the present invention, it is desirable that the above-mentioned O-ring bearing also be used as a bearing supporting the wall driving shaft 24 and the power transmitting shaft 26 arranged inside of the electron beam melting furnace.

Since inside of the shaft driving device 25 and the atmosphere of the melting furnace which is outside of the device are not connected to each other by the above-mentioned O-ring bearing, even in a case in which inside pressure of the electron beam melting furnace is reduced, inside of the shaft driving device 25 can be maintained at normal pressure. Therefore, evaporation loss of lubricating oil from the bearing part can be reduced, and as a result, the bearing can be efficiently prevented from being heated.

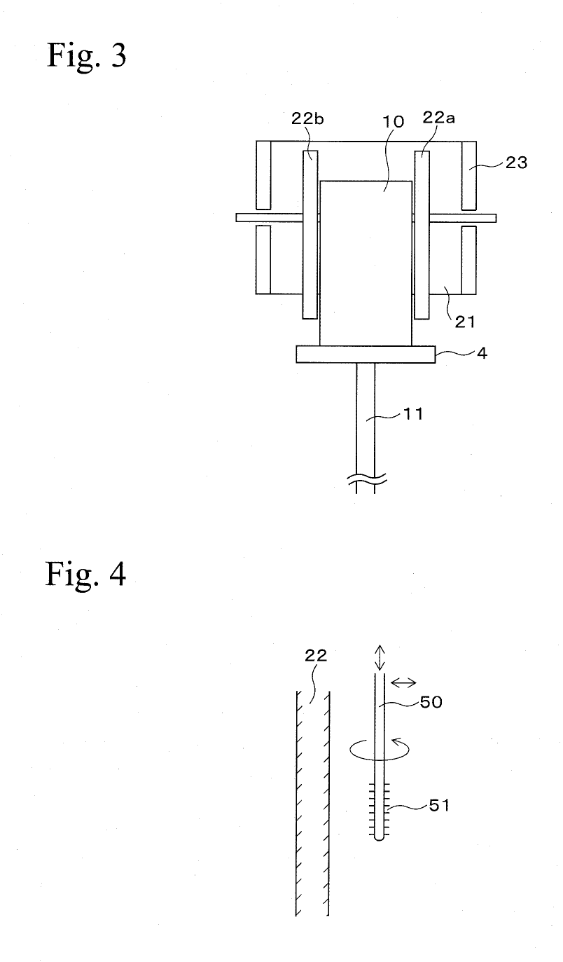

FIG. 3 shows a vertical cross section of the rectangular mold 2. It is desirable that a lower edge of the short mold walls 22 be arranged so as to be more downward than a lower edge of the mold walls of a long side 21. By this structure, since elevation limit of the extraction base 4 can be set at the lower edge of the short mold walls 22, the extraction base 4 can be positioned at an appropriate position.

In the present invention, after the short mold wall(s) 22 are moved until they contact the extraction base 4, it is desirable that the extraction base 4 and the short mold wall(s) 22 be separated by slightly moving the short mold wall(s) 22 back. It is desirable that the distance between the extraction base 4 and the short mold wall(s) 22 being apart be set in a range from 1 to 5 mm.

By arranging the extraction base 4 in the rectangular mold 2 as mentioned above, not only the interaction of the rectangular mold 2 with the extraction base 4, but also with the metal slab 10 generated on the extraction base 4, can be prevented, and thus, the metal slab 10 produced in the rectangular mold 2 can be smoothly pulled out.

In the present invention, the atmosphere inside of the melting chamber 7 is connected to a pressure reducing mechanism, not shown in the figures, by a tube connected penetrating a side wall of the melting chamber 7, and the pressure inside of the melting chamber 7 is maintained in a range from 10⁻³ to 10⁻⁴ Torr, which is appropriate for electron beam melting of a metal.

It is desirable that a concave part be formed on the surface of the extraction base 4. By arranging such a concave part, the metal slab 10 and the extraction base 4 can be reliably engaged.

### Second Embodiment

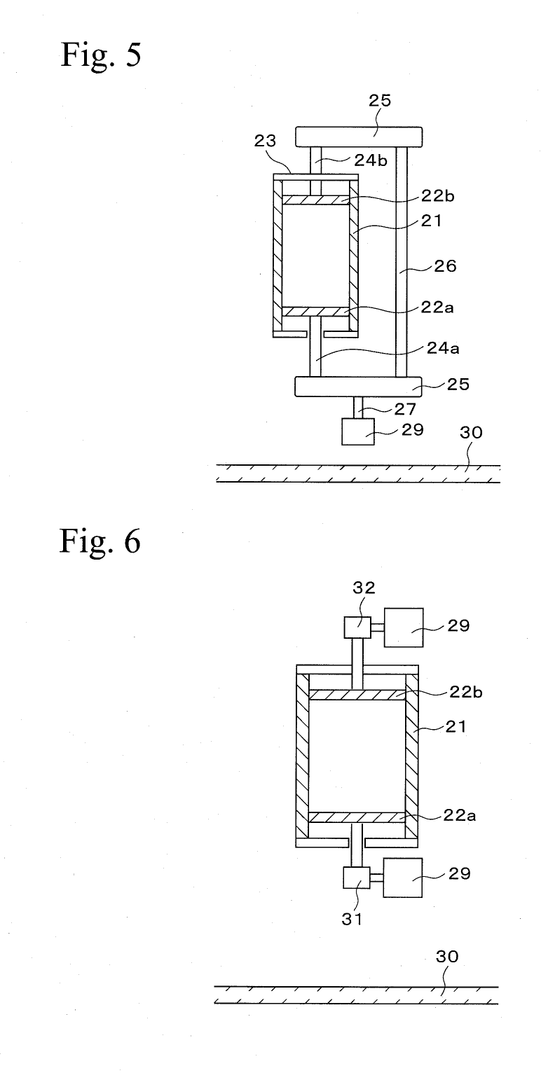

FIG. 5 shows a desirable feature according to a second embodiment of the present invention. In this embodiment, the motor 29 which drives the short mold walls 22a and 22b is arranged inside of the electron beam melting furnace wall 30. As a result, it is not necessary to form a penetrating hole through which the motor driving axis 27 transmits motive power of the motor arranged outside of the furnace to the inside as in FIG. 4, on the furnace wall. Therefore, air is prevented from entering via the penetrating hole.

### Third Embodiment

FIG. 6 shows a desirable feature according to third embodiment of the present invention. In this embodiment, two independent motors 29 separately drive the short mold walls 22a and 22b and are arranged outside of the short mold walls. As a result, alignment of the short mold walls of 22a and 22b can be promoted more accurately than in the cases of the first and second embodiments in which the driving force by one motor is dispersed to a pair of the short mold walls.

### Fourth Embodiment

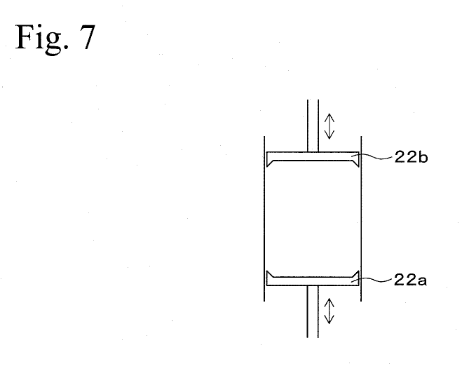

FIG. 7 shows another desirable feature of the short mold walls 22a and 22b according to a fourth embodiment of the present invention. In this embodiment, chamfered parts are formed at both edge parts of the short mold walls 22a and 22b, that is, at parts corresponding to corner parts of the ingot. As a result, heat absorption intensity at the corner parts of the slab produced by using the mold can be reduced, and a good solidified structure is generated at the corner parts of the slab produced.

By the apparatus and method according to the first to fourth embodiments of the present invention, different from a case of continuous casting of steel in which a mold is driven in conditions in which an ingot piece exists inside, width of the rectangular mold 2 can be varied by a small force, and thus, width of the slab produced can be changed without breaking the reduced pressure or vacuum atmosphere in the metal melting part L. A high productivity, which cannot be achieved by a conventional electron beam melting technique can be obtained.

Next, a process of maintenance of the rectangular mold 2 of the present invention is explained. On an inner surface of the rectangular mold 2, attached material may accumulates or molten metal layer may remain as the melting and producing processes are repeated, and there may be a case in which they interrupt extraction of the slab.

To address this problem, it is desirable that a mold inner surface scraping device 50, which penetrates inside of the rectangular mold 2 and can move along the up and down direction shown in FIG. 4, is arranged. By arranging the above-mentioned scraping device 50, the molten metal layer attaching and remaining on inner surfaces of the mold walls of a long side 21 or short mold walls 22 of the rectangular mold 2 after extraction of the slab 10 can be scraped so as to maintain the inner surface of the mold in smooth condition.

By attaching a wire brush 51 on the top part of the scraping device 50, for example, material attaching and remaining on the inner surface of the long mold walls 21 or the short mold walls 22 can be effectively removed.

The process for production of the metal ingot of the present invention can be appropriately employed not only in the case of producing titanium or titanium alloy, but also in the case of producing niobium, tantalum or any other reactive metals.

Furthermore, by reducing a thickness of the rectangular mold used for production of the metal ingot according to the present invention, for example, a titanium slab can be directly melted and produced. The titanium slab can be directly fed into a hot rolling machine. As a result, a conventional hot forging or hot rolling process can be omitted, and thus efficiency of production of thin plate material can be improved.

As mentioned above, by using the apparatus and method according to the present invention, the metal ingot can be continuously produced without breaking reduced pressure or vacuum conditions in the metal melting part L in which the hearth, mold and electron gun are arranged. Furthermore, by using the mold of variable wall distance, slabs, each having different width, can be effectively produced, which is an effect that is not possible to achieve by a conventional electron beam melting technique.

Furthermore, in the present invention, since width of the mold can be varied not only to be lengthened, but also to be shortened, a schedule for producing the metal ingot can be freely decided.

### EXAMPLES

### Example 1

Using the apparatus shown in FIGS. 1 and 2, without opening the metal melting part of the electron beam melting furnace to the atmosphere, and maintaining reduced pressure, 5 titanium slabs, each 5 slabs having 3 kinds of widths and all having a weight of 10 t, for a total of 15 titanium slabs, were produced. Colored parts, which are evidence of generation of oxides or nitrides formed by contacting of the surface of the slab produced and air, were rarely observed.

### Example 2

Using the apparatus in which a pair of driving motors is arranged inside of the melting furnace (See FIG. 6) and the chamfered parts are formed on the short mold walls (See. FIG. 7), 3 titanium slabs, each 3 slabs having 3 kinds of widths and all having a weight of 10 t, for a total of 9 titanium slabs were produced. Not only was the ingot surface of the slab produced smooth, but also significantly colored parts, which are due to generation of oxides or nitrides, were rarely observed. There was almost no colored part, and thus it was superior to the case of Example 1. Furthermore, there was no damage such as cracking at the corner parts of the slab, and it was confirmed that the slab had good solidifying structure.

### Comparative Example 1

Except that using a mold of which the width is fixed rather than using the mold of variable wall distance, and except that the electron beam melting furnace was dismantled when replacing the mold, 15 titanium slabs were produced in a manner similar to that of Example 1.

The time required to produce the 15 titanium slabs in Example 1 was shortened by 40% compared to that in Comparative Example 1. As a result, productivity in Example 1 is improved 1.5 times.

By the present invention, the widths of molds for reactive metals for which melting and production must be performed under reduced pressure or a vacuum condition, can be varied without returning the inside pressure to normal pressure, and thus productivity of the metal slab can be improved.

1. An apparatus for production of a metal slab by using an electron beam melting furnace, comprising:
a part of melting metal and a part of extracting the metal slab which can be separable by an air tight valve,
the part of melting metal comprising:
a melting chamber,
an electron gun,
a hearth,
a rectangular mold of a variable wall distance, and
an air tight valve,
the part of extracting the metal slab comprising:
a slab chamber,
an extraction base unit,
an extracting shaft, and
a driving unit for extracting the metal slab.

2. The apparatus for production of a metal slab according to claim 1,
wherein the mold of variable wall distance comprises a pair of long mold walls and a pair of short mold walls, and
the short mold walls can be slidably moved by a wall drive shaft arrangement through a shaft guide along the surface of the long mold walls.

3. The apparatus for production of a metal slab according to claim 2,
wherein one wall driving shaft is connected to one short mold wall, and the other wall driving shaft is connected to the other short mold wall, the mold walls facing each other,
one wall driving shaft is connected to a motor via a shaft driving device and motor driving shaft, and
the other wall driving shaft is connected to the motor via a shaft driving device and power transmitting shaft and a motor driving shaft.

4. The apparatus for production of a metal slab according to claim 2,
wherein the motor drive shaft is connected to the motor arranged outside the electron beam melting furnace, via an O-ring bearing installed through the furnace wall of the electron beam melting furnace.

5. The apparatus for production of a metal slab according to claim 2,
wherein the power transmitting shaft is connected to the shaft driving device via the O-ring bearing.

6. The apparatus for production of a metal slab according to claim 3,
wherein one wall driving shaft is connected to the motor via the shaft driving device and the motor driving shaft,
the other wall driving shaft is connected to the shaft driving device, the power transmitting shaft, the motor driving shaft, and the motor, and
the motor and all the driving devices are arranged inside the electron beam melting furnace.

7. A process for production of a metal slab, in which the apparatus for production of the metallic slab according to claim 1 is used, comprising:
a step of extracting a previous metal slab produced in the rectangular mold,
a step of moving the short mold walls comprising the rectangular mold to change the width of the rectangular mold, and
a step of producing a subsequent metal slab having a width different from the previous one.

8. The process for production of a metal slab according to claim 7,
wherein the short mold walls of the rectangular mold are moved so that the width of the rectangular mold is reduced.

9. The process for production of a metal slab according to claim 7,
wherein only one short wall of the rectangular mold is moved in the change of the width of the rectangular mold.

10. The process for production of a metal slab according to claim 7,
wherein the following steps are performed after melting and producing the metal slab:
step 1: the extracting base for the slab is moved upwardly until the extracting base unit moves into the rectangular mold,
step 2: after the extracting base is moved into the rectangular mold, the short mold walls of the rectangular mold are contacted to the extracting base, and then the short mold walls are moved apart from the extracting base so that the extracting base unit can be moved downwardly,
step 3: molten metal is poured from the hearth into the rectangular mold, and at the same time, the extracting base is continuously moved downwardly so as to produce a metal slab having a predetermined length,
step 4: after producing the metal slab, the extracting base unit and the metal slab are downwardly moved together until the whole metal slab is placed into the slab chamber, with extracting the metal slab from the rectangular mold,
step 5: after the metal slab is extracted into the slab chamber, the air tight valve is operated so that the melting chamber is separated from the slab chamber and the slab chamber is resumed to a normal pressure and cooled, and then the metal slab produced is taken out of the slab chamber,
step 6: after the melting chamber is isolated by the air tight valve, while maintaining the melting chamber at a reduced pressure, the short mold walls of the rectangular mold are displaced to change the width of the mold, and
step 7: another extracting base fitted to the mold with a width having been changed, is inserted into the rectangular mold, and then another slab melting and producing is restarted.

11. The process for production of a metallic slab according to claim 7,
wherein the metal is one selected from the group consisting of pure titanium, niobium, tantalum, and an alloy that contains at least one of these.
